(19) United States
(12) Patent Application Publication
(10) Pub. No.: US 2009/0313989 A1
(43) Pub. Date: Dec. 24, 2009

(54) Rotary stirling cycle machine

(76) Inventor: Lee E. Doss, Grand Ronde, OR (US)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/214,988

(22) Filed: Jun. 23, 2008

(51) Int. Cl. F02G 1/043

(52) U.S. Cl. 60/519

(57) ABSTRACT

A rotary Stirling cycle engine including motor and pump rotors located eccentrically in motor and pump chambers arranged endwise adjacent each other, with both rotors on a single drive shaft. The pump and motor chambers may be shaped as circular cylinders. Working fluid inlet and outlet ports are located in motor and pump chamber ends. A bypass conduit may include a valve allowing working fluid to bypass the motor chamber.

### BACKGROUND AND SUMMARY OF THE INVENTION

The present invention relates to rotary machines and particularly to a machine which may be operated as a rotary Stirling cycle engine or heat pump.

Stirling cycle engines of many types have been designed, including various rotary machines, as exemplified by the disclosures in Kelly U.S. Pat. Nos. 3,370,418; 3,488,945; 3,492,818; 3,537,256; and 3,958,422; and Hecker U.S. Pat. No. 4,357,800.

Since they utilize a contained working fluid, Stirling cycle engines are best suited to constant speed operations and previously known Stirling cycle engines have included complex mechanisms in order for their speed to be controllable, as seen, for example, in Edwards U.S. Pat. No. 4,415,171.

Disclosed herein is a rotary Stirling cycle machine useful primarily as an engine, but which might also be used as a heat pump driven by an outside source of mechanical power. As defined by the claims which form a part hereof, the present disclosure is directed to a Stirling cycle machine in which motor and pump rotors are mounted on a shaft extending through a motor chamber and a pump chamber in an eccentric location with respect to each. Outwardly extending vanes on the rotors cooperate to contain quantities of the working fluid within the motor chamber and the compressor or pump chamber during expansion or compression of the working fluid. Inlet and outlet ports are provided in an end of the motor chamber and in the end of the pump chamber, so that movement of the vanes effectively opens or closes each inlet or outlet port with respect to a particular compartment defined between a pair of successive vanes associated with the respective rotor within the motor or pump chamber.

In a heat engine that is one embodiment of the apparatus disclosed herein a bypass conduit is provided between an outlet conduit from a high temperature heat exchanger and an inlet conduit of a low temperature heat exchanger, and a throttle valve is provided in the bypass conduit to allow working fluid to bypass the inlet and outlet ports of the motor, in order to control the speed of the Stirling cycle engine.

In one embodiment of the engine disclosed herein vanes are mounted in a motor rotor or pump rotor in a manner that allows them to move angularly to keep a tip or radially outer edge of each vane engaged with an interior surface of a motor or pump chamber wall.

In one embodiment of the engine disclosed herein vanes are disposed in radially oriented slots in a motor rotor or pump rotor and are urged radially outward into contact with an interior surface of a motor chamber or pump chamber by springs.

The foregoing and other features of the invention will be more readily understood upon consideration of the following detailed description of the invention taken in conjunction with the accompanying drawings.

### BRIEF DESCRIPTION OF THE DRAWINGS

FIG. 1 is an isometric view of an exemplary Stirling cycle engine, together with an associated pair of heat exchangers.

FIG. 1A is an isometric view of an exemplary Stirling cycle engine of a small size, of which parts are held together by longitudinally extending tension rods.

FIG. 2 is a top plan view of the engine and heat exchangers shown in FIG. 1.

FIG. 3 is a sectional side view of the engine shown in FIGS. 1 and 2, taken along line 3-3 in FIG. 2.

FIG. 4 is a sectional view of the fluid expansion, or motor, section of the Stirling cycle engine shown in FIGS. 1-3, taken along line 4-4 in FIG. 2.

FIG. 5 is a detail view of a tip of a rotor vane and a portion of an adjacent interior surface of the motor chamber of the Stirling cycle engine shown in FIG. 4.

FIG. 6 is a sectional view of the fluid compressor, or pump, section of the Stirling cycle engine shown in FIGS. 1-3, taken along line 6-6 in FIG. 2.

FIG. 7 is a detail view of a tip of a vane and an adjacent interior surface of the pump chamber of the Stirling cycle engine shown in FIG. 6.

FIG. 8 is a view of the motor side of the center wall of the Stirling cycle engine shown in FIGS. 1 and 2, taken in the direction of line 8-8 in FIG. 2.

FIG. 9 is a view of the pump side of the center wall of the Stirling cycle engine shown in FIGS. 1 and 2, taken in the direction of line 9-9 in FIG. 2.

FIG. 10 is a view similar to FIG. 6, showing a compressor, or pump portion of a Stirling cycle engine in accordance with the present disclosure, in which a pivoted vane structure is used as an alternative to the radially sliding vanes shown in FIG. 6.

FIG. 11 is a view similar to FIG. 6, showing a compressor, or pump portion of a Stirling cycle engine in accordance with the present disclosure, in which a different pivoted vane structure is used as another alternative to the radially sliding vanes shown in FIG. 6.

### DETAILED DESCRIPTION OF EMBODIMENTS

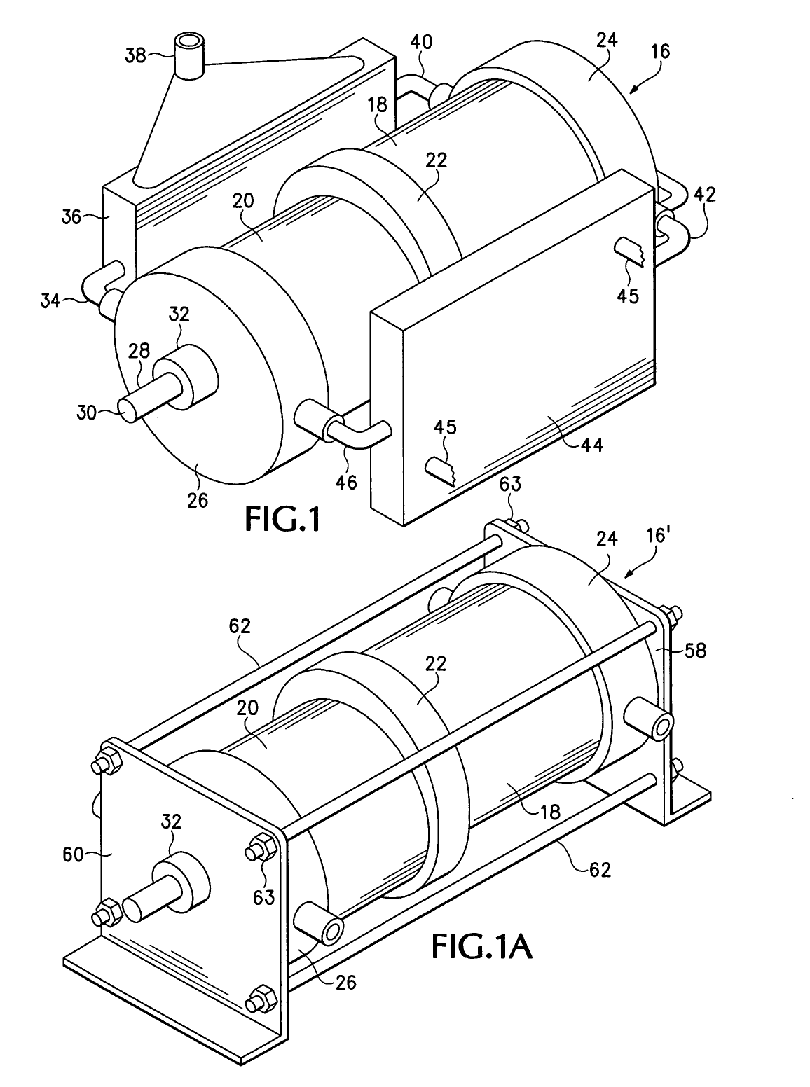

Referring to the drawings which form a part of the disclosure herein, a Stirling cycle heat engine 16 shown in FIG. 1 includes a motor portion 18 and a pump portion 20 located endwise adjacent each other and separated by a center wall 22. A motor chamber outer end member 24 is located at an outer end of the motor portion 18, and a pump chamber outer end member 26 is located at an outer end of the pump portion 20. A drive shaft 28 extends longitudinally from the pump chamber outer end member 26, through the motor portion 18, through an opening 29 through the center wall 22, and through the pump portion 20, and may have an outer or power takeoff end portion 30 extending from the pump portion 20 and supported by a suitable bearing 32 associated with the pump chamber outer end member 26. A shaft seal, which may include a series of several O-rings 33, is located in the pump chamber outer end member 26.

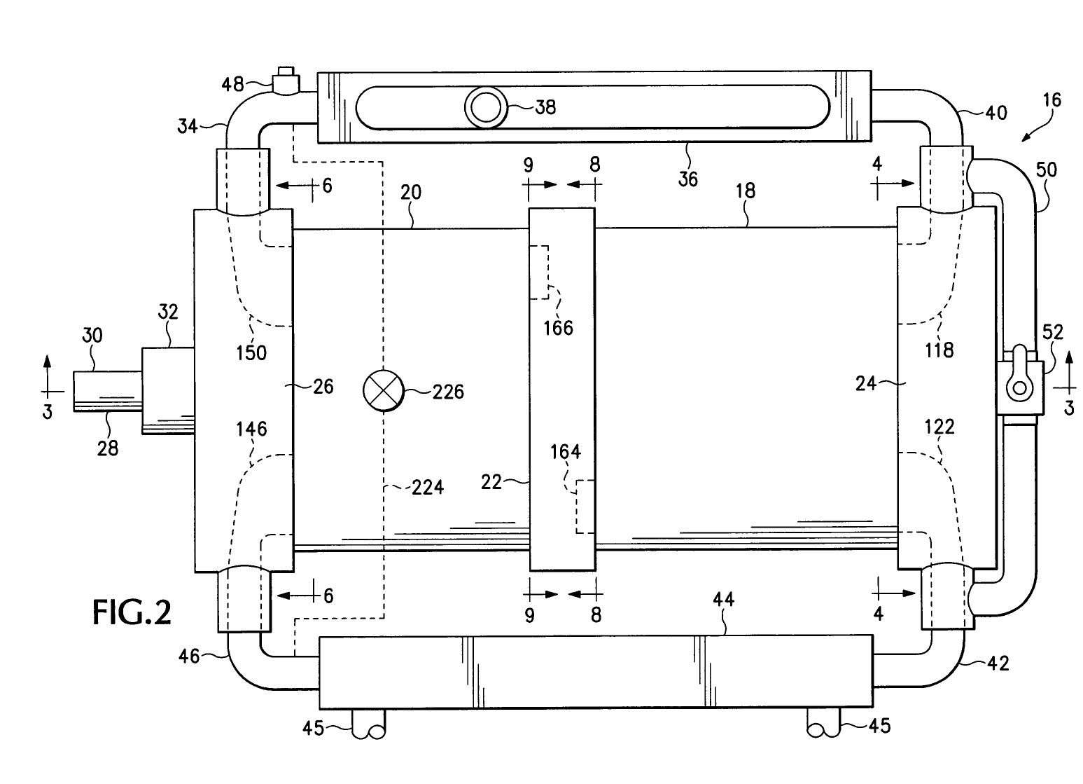

As may also be seen in FIG. 2, a conduit 34 extends from an outlet fitting on the pump chamber outer end member 26 to an inlet of a heat exchanger 36, in which a working fluid contained within the heat engine 16 may be heated by an available source of heat (not shown in detail), such as gas burners, a flow of geothermally heated water, or a supply of solar heated water or steam. The heat exchanger 36 may thus include, for example, a gas burner outlet flue 38, or where a flow of hot liquid or gas from a remote source is used as a heat source other appropriate fittings (not shown) would be used. An outlet conduit 40 carries heated working fluid from an outlet of the heat exchanger 36 into an inlet port fitting on the motor chamber outer end member 24.

An outlet conduit 42 extends from an outlet fitting associated with the motor chamber outer end member 24 and conducts the working fluid to the inlet of a cooling heat exchanger 44 through which the working fluid passes and in which it is cooled. An appropriate coolant, such as a flow of chilled water from an available natural source, or a supply of water that is desired to be heated for use apart from the heat engine 16, may be circulated through the heat exchanger 44 by use of appropriate fittings 45. A conduit 46 is connected to an outlet end of the heat exchanger 44 and leads the cooled working fluid from the heat exchanger 44 into an inlet fitting on the pump chamber outer end member 26.

Since the design of heat exchangers is well known and does not form a part of the present invention the heat exchangers 36 and 44 are shown in greatly simplified form.

As shown in FIG. 2, a suitable fitting 48, shown without detail, may be provided at a convenient location, such as along the conduit 34, to connect a pressure gauge, a pressure relief safety valve, or a fill valve for replenishing the working fluid within the heat engine 16.

A bypass conduit 50 extends from the conduit 40, adjacent the inlet fitting on the motor chamber outer end member 24, to the conduit 42 adjacent the outlet fitting on the motor chamber outer end member 24. A throttle valve 52, normally kept in a closed condition, is located in the conduit 50 and may be opened as desirable to allow some or most of the working fluid to bypass the motor portion 18 at times, as will be explained in greater detail presently.

The structure of the body of the heat engine 16 is shown in a simplified form in FIGS. 1, 2, and 3. The motor chamber outer end member 24, pump chamber outer end member 26, center wall member 22, motor chamber body member 54 and pump chamber body member 56 may be assembled and kept together by any of several well known means of interconnection, depending upon the size of the heat engine 16, such as by the use of appropriate flanges and connecting bolts (not shown), or even by welding the parts together with critical relationships established by machined mating surfaces and alignment features.

For a heat engine 16′, shown in FIG. 1A, end plates 58 and 60 and tensioned rods 62 with appropriate nuts 63 on their opposite threaded ends may be used to hold the components of the heat engine 16′ together in an assembled condition if the heat engine 16′ is of a limited size and is operated with the working fluid at a sufficiently low pressure.

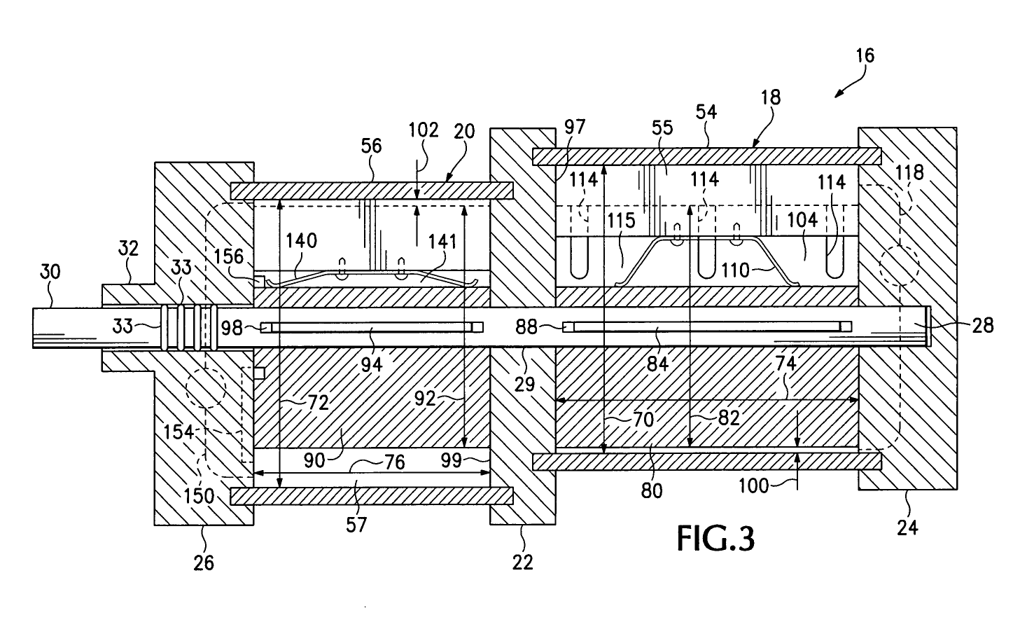

As shown in FIG. 3, the drive shaft 28 extends through the entire length of the engine 16 and is supported in suitable bearings (not shown) such as suitably lubricated friction bearings in the motor chamber outer end member 24 and the center wall member 22, and in the pump chamber outer end member 26 the bearing 32 may also include a thrust bearing. The motor chamber body member 54 and the pump chamber body member 56, in their simplest forms, may be hollow circular cylinders, with the internal diameter 70 of the motor chamber body member 54 equal to the internal diameter 72 of the pump chamber body member 56. Alternatively, the motor and pump body members 54 and 56 could be oval cylinders, with maximum lateral dimensions 70 and 72, but non-circular cylinders add complexity and thus would not always be desirable.

The motor chamber body member 54, together with the center wall member 22 and the motor chamber outer end member 24, defines a motor chamber 55. The pump chamber body member 56, together with the center wall member 22 and the pump chamber outer end member 26, defines a cylindrical pump chamber 57. The internal length 74 of the motor chamber 55, between the center wall member 22 and the motor chamber outer end member 24, is greater, however, than the internal length 76 of the pump chamber 57, between the center wall member 22 and the pump chamber outer end member 26. As may be seen in FIGS. 1 and 3, the motor portion 18 and pump portion 20 are parallel, but located offset radially from each other where they are mated with the center wall member 22, so that the shaft 28 is located eccentrically within both the motor chamber 55 and the pump chamber 57, but the pump and motor portions 18 and 20 are offset in opposite directions with respect to the shaft 28.

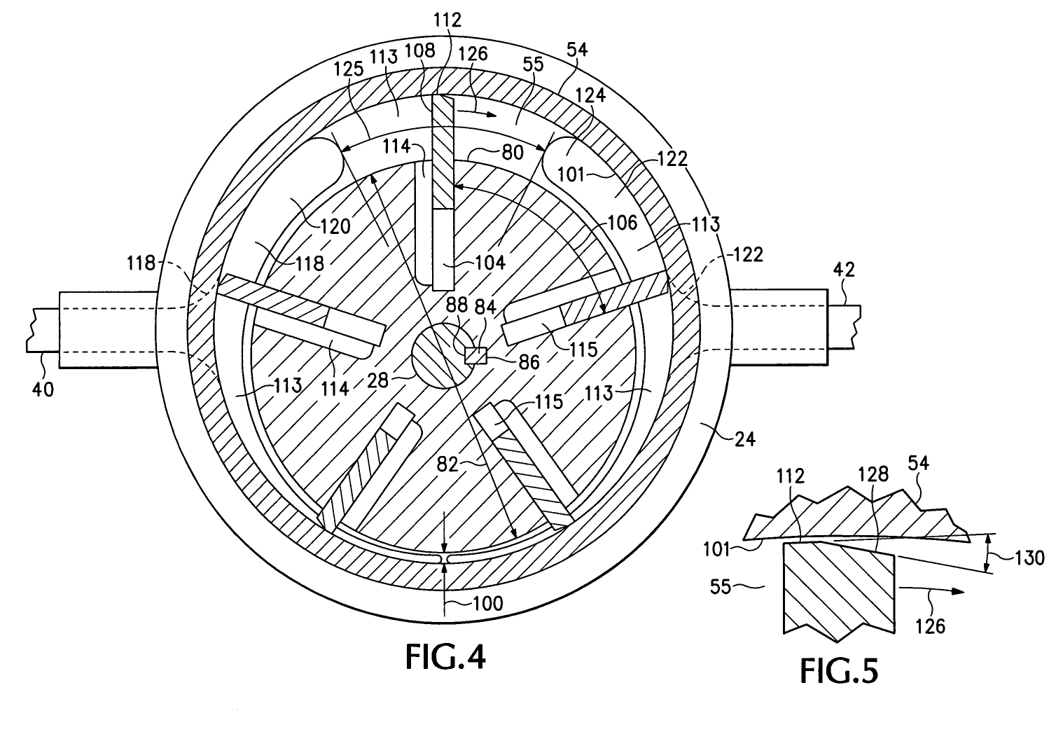

As may be seen in FIG. 4, a motor rotor 80 is generally circularly cylindrical, but has a smaller diameter 82 than inside diameter 70 or other maximum lateral dimension of the motor chamber 55, and is located eccentrically in the motor chamber 55. The shaft 28 extends centrally through the motor rotor 80, parallel with its length, and the motor rotor 80 is connected to the shaft 28 for rotation therewith, such as by a suitable key 84 fitted in keyways 86 and 88 defined respectively in the rotor 80 and the shaft 28.

Similarly, a generally circularly cylindrical pump rotor 90 within the pump chamber 57 has a diameter 92 that is less than the inside diameter 72, or other maximum lateral dimension of the pump chamber 57 and that may be equal to the diameter 82 of the motor rotor 80. The pump rotor 90 is also fastened to the shaft 28 for rotation therewith, such as by a suitable key 94 interconnecting a keyway 96 in the rotor 90 with a keyway 98 defined by the shaft 28.

When the diameter 82 of the motor rotor 80 and the diameter 92 of the pump rotor 90 are identical, the ratio of the size of the motor chamber 55 to the pump chamber 57 is conveniently the same as the ratio of the length 74 of the motor chamber to the length 76 of the pump chamber.

A small axial clearance is provided in the motor chamber 55 between the motor rotor 80 and the adjacent interior surface of the motor chamber outer end member 24 and the surface 97 of center wall member 22, leaving room for a thin but effective film of a lubricant, having a thickness, for example, on the order of 0.002 inch at each end of the rotor 80 at operating temperatures.

Similarly, in the pump chamber 57 a small axial clearance, which may be on the order of 0.002 inch, is provided for each end of the pump rotor 90 to permit a film of lubricating material to be present between the pump rotor 90 and the adjacent surface 99 of the center wall member 22 and the interior face of the pump chamber outer end member 26.

In the embodiment of the heat engine 16 disclosed in FIGS. 1 and 2-9, the drive shaft 28 is located equally eccentrically within the motor chamber 55 and pump chamber 57. Thus there is small radial clearance 100 between the motor rotor 80 and the arcuate interior surface 101 of the motor chamber body member 54 at the bottom of the motor chamber 55 as shown in FIGS. 3 and 4, although the clearance 100 is shown greatly exaggerated in FIGS. 3 and 4. The rotor 90 is located with a similarly small radial clearance 102 between it and the interior surface 103 of the pump chamber 57 as shown at the top of each of FIGS. 3 and 5. The clearances 100 and 102 may be small, as long as they avoid interference between each rotor 80 or 90 and the adjacent motor or pump chamber wall interior surface 101 or 103, and so long as they provide enough space for an effective film of a lubricant throughout the range of temperatures to be encountered.

In one such heat engine 16 intended for developmental experimentation the rotor diameters 82 and 92 may be about 3.8 inches and the motor chamber diameter 70 and pump chamber diameter 72 may be about 4.7 inches, while the motor chamber length 74 is about 7 inches and the pump chamber internal length 76 is about 5 inches. The engine 16 may be made of steel, or for greater efficiency other materials capable of withstanding the expected temperatures and pressures may be used, including exotic metals and composite materials such as carbon fibers.

As shown in FIG. 4, the motor rotor 80 may include five radially oriented vane-receiving slots 104 spaced apart by equal angles 106 about the shaft 28, and a motor vane 108 is slidingly disposed within each vane slot 104. It will be understood that a greater or smaller number of slots 104 and vanes 108 might be utilized, depending various factors such as sizes, pressures, temperatures, and materials. A vane spring 110 may be attached to a radially inner part of each of the vanes 108 to urge the vane radially outwardly within its slot 104 and thus to bring a tip surface 112 of each vane 108 into sealing contact against the arcuate interior surface 101 of the motor chamber 55, regardless of whether the motor rotor 80 is turning at an angular velocity sufficient for the vane 108 to be urged radially outward into contact with the interior surface 101 by centrifugal force. Thus a compartment 113 is defined between each pair of successive vanes 108, to contain a quantity of working fluid as it expands.

Additionally, narrow channels 114, which may be seen in FIGS. 3 and 4, may be defined in the rotor 80. The channels 114 extend radially inward alongside and in communication with the vane-receiving slots 104 on a rear side of each vane 108, so that working fluid under pressure can move through the channels 114 into the motor vane root space 115 in the vane slots 104, beneath the motor vanes 108 to assist in urging the vanes radially outwardly into sealing contact with the interior surface 101 of the motor chamber 55. As shown in FIG. 3 there may be three such channels 114, although a greater or lesser number may be used instead, depending upon the size of the motor portion 18 of the heat engine 16. The motor vane root spaces 115 are thus exposed to cyclically varying pressure of working fluid as the motor rotor 80 rotates.

As shown best in FIG. 4, and as shown in FIGS. 2 and 3 in broken line, the motor chamber outer end member 24 defines an inlet port 118 including an expanding nozzle leading from the inlet fitting to which the working fluid conduit 40 is connected to the interior of the motor chamber 55. The inlet port 118 defines an opening that extends arcuately along the exterior of the motor rotor 80, where the radially outer edge of the outer end of the motor rotor 80 is located, adjacent the otherwise generally flat inner surface of the motor chamber outer end member 24. The inlet port 118 increases in radial width as space is available between the rotor 80 and the interior surface 101, from a position where the clearance 100 is least, and extends along the interior surface of the wall of the motor chamber 55, as shown in FIG. 4. The inlet port 118 is designed to have sufficient capacity to accommodate the flow of working fluid through the conduit 40.

Also defined in the motor chamber outer end member 24 is a motor outlet port 122 communicating with the outlet fitting to which the working fluid conduit 42 is connected. The motor outlet port 122 may be shaped as a mirror image of the motor inlet port 118 and also is located between the interior surface 101 of the motor chamber 55 and the exterior of the motor rotor 80, between the location of minimum clearance 100 and a location near where the radial clearance between the motor rotor 80 and arcuate interior surface of the motor chamber 55 is greatest. The motor outlet port 122 is also designed not to restrict the flow of working fluid to any greater degree than the adjacent conduit 42 leading away from the port 122. A wide end 120 of the inlet port 118 is separated from a wide end 124 of the motor outlet port 122 by an angle 125, measured around shaft 28, whose size is at least nearly equal to the angle 106 between successive vane-receiving slots 104. The separation prevents having both the motor inlet port 118 and the motor outlet port 122 exposed between any two successive vanes 108 as the motor rotor 80 turns in the direction indicated by the arrow 126 in response to the pressure of working fluid entering into the motor chamber 55 through the motor inlet port 118, as will be explained in greater detail presently.

As the motor rotor 80 rotates in the direction indicated by the arrow 126, a surface 128, oriented at a small angle 130 with respect to the vane tip surface 112, as shown in FIG. 5, admits a small amount of lubricating material, such as a suitable oil or high temperature lubricating powder entrained in the working fluid, to collect and form a thin lubricating film between the vane tip surface 112 and the arcuate interior surface 101 of the motor chamber 55.

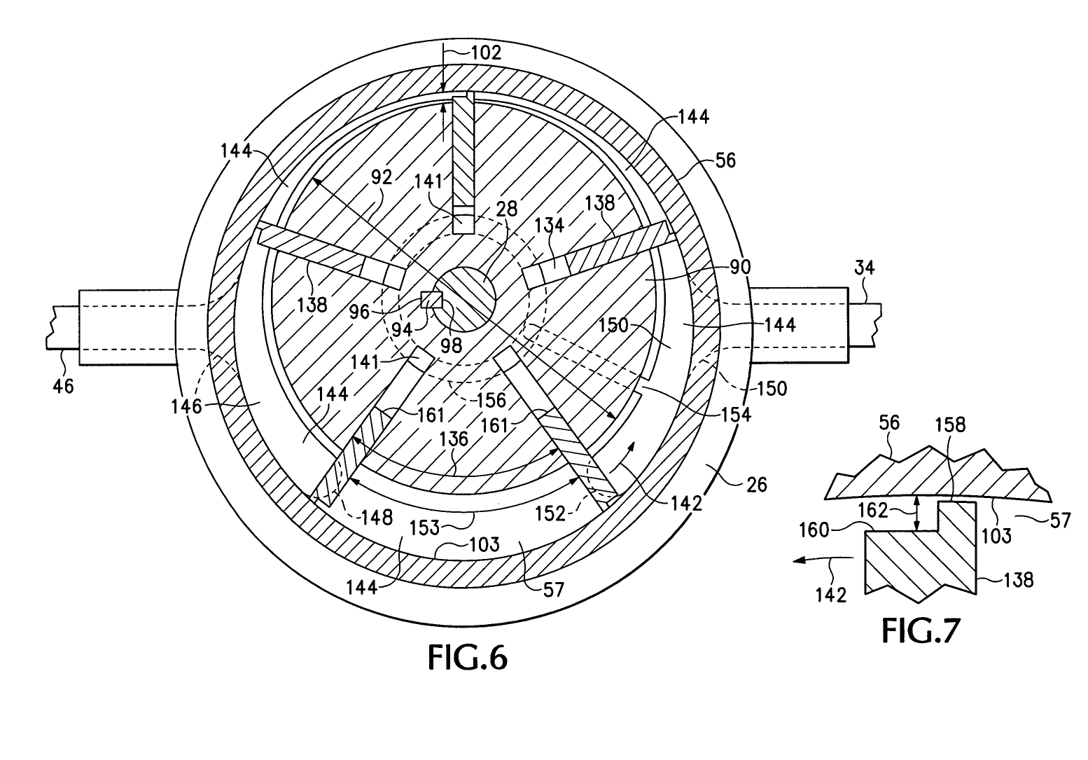

In the pump portion 20 of the heat engine 16, as shown best in FIG. 6, a similar arrangement is provided, with radially oriented vane-receiving slots 134 being separated by equal vane-spacing angles 136 about the shaft 28, and with a pump vane 138 located in each vane-receiving slot 134 and slidably movable in a radial direction therein. Pump vane springs 140 may be provided as shown in FIG. 3 in a pump vane root space 141 in each slot 134 beneath each pump vane 138, to urge each pump vane 138 radially outward into sealing contact against the arcuate interior surface 103 of the pump chamber 57, at least when the pump rotor is not rotating fast enough in the direction indicated by the arrow 142 for centrifugal force to move the pump vanes 138 outward into contact with the interior surface 103. Compartments 144 are thus defined between successive pump vanes 138 to contain quantities of working fluid as the pump rotor 90 rotates in the pump chamber 57. A pump inlet port 146 is provided in the pump chamber end member 26 and is similar in shape to the motor outlet port 122, tapering from a wide end 148 as it extends arcuately along the outer surface of the pump rotor 90 toward the location of minimum clearance 102. The pump inlet port 146 is in fluid communication with the interior of the conduit 46 extending from the heat exchanger 44 toward the pump chamber outer end member 26, as shown in FIG. 1.

A pump outlet port 150, also shown in broken line in FIGS. 2 and 3, may be generally similar in shape to the motor inlet port 118 and is in fluid communication with the interior of the working fluid conduit 34 leading to the heat exchanger 36. A wide end 152 of the pump outlet port 150 faces toward the wide end 148 of the pump inlet port 146, as seen in FIG. 6, and is separated angularly from the wide end 148 by at least about the distance 153 between successive pump vanes 138, so that there is never an opportunity for direct communication between the pump inlet port 146 and the pump outlet port 150 within the pump chamber 57.

A channel 154 which may be defined as a groove in the interior surface of the pump chamber end member 26 extends radially from the pump outlet port 150 alongside the generally flat end surface of the pump rotor 90, as shown in FIGS. 2 and 6. The channel 154 intersects with a circular channel 156 defined in the pump rotor 90, to serve as a passageway through which working fluid under pressure can flow into the radially inward portions, or pump vane root spaces 141, of the pump vane-receiving slots 134 to assist in urging the pump vanes 138 radially outward within the vane-receiving slots 134 during operation of the heat engine 16.

As shown in FIG. 7, a radially outward tip portion 158 of each vane 138 is thinner than the full thickness of the vane 138, and a shelf 160 defined along a radially outer margin of the vane 138 provides a gap 162 large enough in a radial direction so that working fluid pressure within the pump chamber 57 can act on the shelf 160. The shelf 160 acts as a piston opposing the pressure of the working fluid on the wider radially inward marginal face 161 of each pump vane 138, to prevent an excessive amount of force being exerted by the outer tip surface 158 of the pump vane against the concave arcuate interior wall surface 103 of the pump chamber 57 during operation. Additionally, the gap 162 allows a small quantity of lubricating material to collect and form a lubricating film between the outer tip surface 158 and the concave arcuate interior surface 103 of the pump chamber 57.

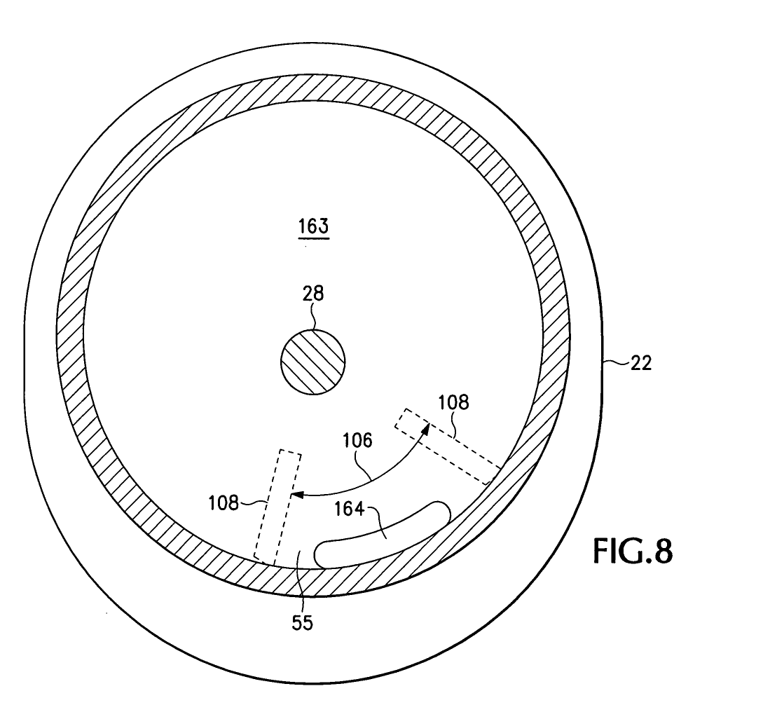

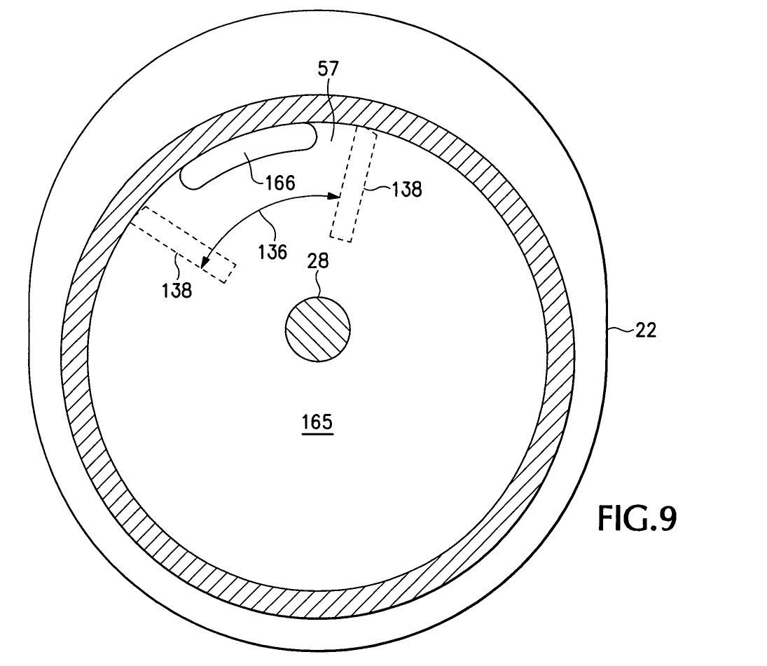

As shown in FIGS. 8 and 9, the center wall 22 has a generally planar face 163 forming the central or inner end of the motor chamber 55, and the central end of the motor rotor 80 is located closely adjacent the face 163, within the motor chamber 55. On the opposite side of the center wall 22, a generally planar face 165 forms the central end of the pump chamber 57, adjacent which the central or inner end of the pump rotor 90 is located within the pump chamber 57. In order to promote a small amount of longitudinal movement of the working fluid within the motor chamber 55, a small circumferentially extending working fluid conduit 164 is defined as a short, narrow, shallow channel in the face 163, so that a small amount of gas can move around the adjacent radially outward end of each of the motor vanes 108 as that vane moves along the conduit 164 during through a small angular portion of each revolution of the motor rotor 80.

Similarly, as shown in FIG. 9, a working fluid conduit 166 extends circumferentially about a radially outward part of the face 165 of the center plate 22 within the pump chamber 57. The conduit 166 is in the form of a narrow shallow channel defined in the face 165 and provides a path for a small amount of working fluid to flow around a radially outward end of each of the pump vanes 138 as the respective pump vane 138 rotates through a small angular portion of each revolution of the pump rotor 90. In order to permit only a small amount of working fluid to move around each of the vanes 108 or 138, the conduits 164 and 166 subtend an angle, measured with respect to the central axis of the shaft 28, that is less than the angle 125 or 153 between adjacent ones of the vanes 108 or 138 shown in FIGS. 4 and 5.

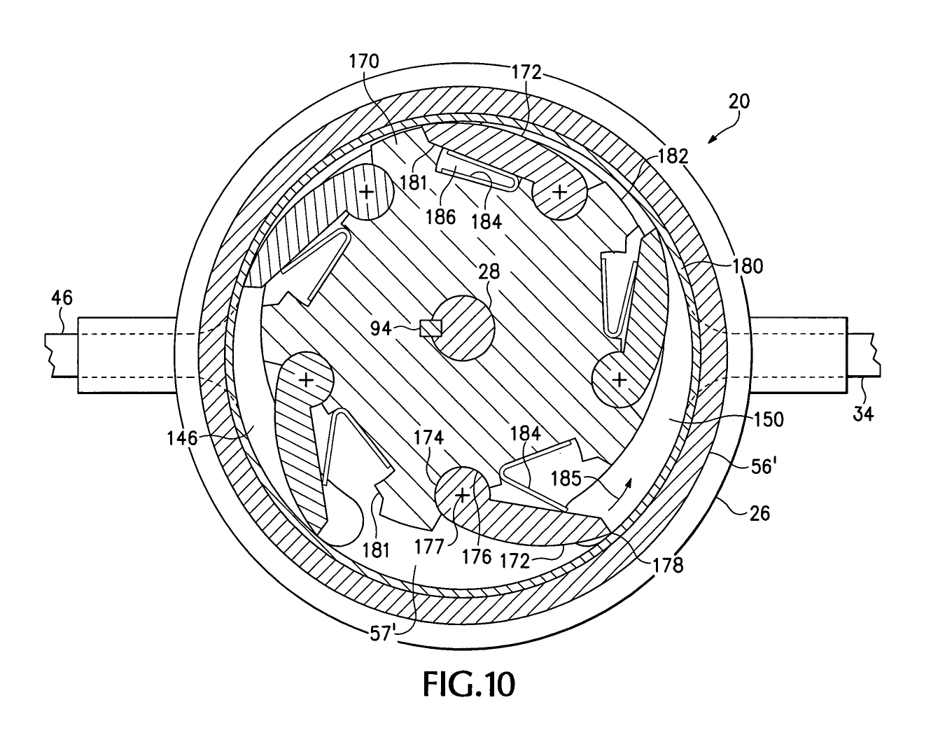

Referring next to FIG. 10, a pump rotor 170, instead of having radially aligned sliding rotor vanes as in the pump rotor 90, is equipped with vanes 172 each having a root 174 mounted in a bearing portion 176 of the rotor 170 and having a radially outwardly located vane edge or tip 178 in contact with a liner sleeve 180 within the circular cylindrical pump chamber 57′. Each vane 172 can pivot as a gate about an axis 177 established by its bearing 176, from a position such as that shown at the top of FIG. 10, where the vane 172 is seated within a receptacle 181 defined in the periphery of the motor rotor 170 and the tip 178 of the vane is barely proud of a cylindrical peripheral surface 182 of the motor rotor, to an angularly extended position such as that shown near the bottom of FIG. 10. One or more springs 184, each having generally the shape of a “U,” are held in a seat or seats 186 defined in the motor rotor 170, so that one leg of each spring 184 rests against a radially inward side 188 of a respective vane 172, urging it to pivot outward in the bearings 176 so that the vane tip 178 is kept bearing sealingly against the interior surface of the liner sleeve 180, when the pump rotor 170 is rotating in the direction of the arrow 185, but at a speed too small for centrifugal force to urge the vanes 172 outward radially away from the shaft 28. The spring 184 could extend over the entire length of pump chamber or motor chamber in which a rotor similar to the pump rotor 170 is utilized, or there could be one or more of such springs 184 located at one or more separate locations along the length of each vane 172 and kept in place by suitable locators (not shown).

The liner sleeve 180 may be free to slip angularly and rotate within the pump chamber body member 56′. A similar arrangement of a liner sleeve such as the liner sleeve 180 could also be used within the motor chamber body member 54 and pump chamber body member 56 in the heat engine 16, in conjunction with the motor rotor 80 and pump rotor 90, if desired, so long as they are of circular cylindrical shape. Such a liner sleeve would need to be enough shorter than the interior length 74 or 75 of the respective motor chamber 55 or pump chamber 57 and would need to have sufficient radial clearance within the motor chamber body member 54 or pump chamber body member 56 to be free to float and rotate within the motor chamber 55 or pump chamber 57. The outer surface of the liner 180 may be provided with channels (not shown) to carry a flow of a lubricant, to keep the liner 180 freely movable.

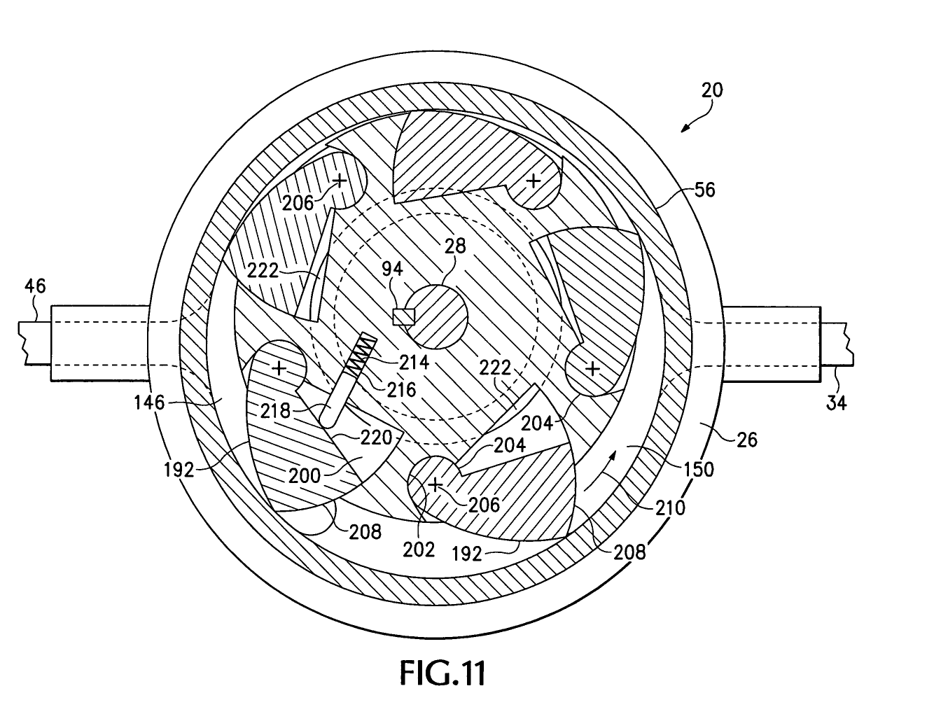

As shown in FIG. 11, a pump rotor 190 is also equipped with vanes 192 that are mounted for oscillatory rotation through a small angle from a position in which an outer surface 194 of a vane 192 is essentially flush with a cylindrical peripheral surface 196, as shown in the upper portion of FIG. 11. In a radially extended position as shown near the bottom of FIG. 11, an outer edge or tip 198 of a vane 192 rests in sealing contact against an arcuate interior surface 103 of a pump chamber body member 56. The pump rotor 190 defines receptacles 200 to receive the vanes 192, as bearings 202 holding the roots 204 of the vanes 192 allow the vanes 192 to pivot inward about their respective pivot axes 206.

A driving face 208 of each vane is oriented toward the direction of rotation of the pump rotor 192, indicated by the arrow 210, so that the vanes 192 can act upon working fluid within the pump chamber 57. In the case of a motor portion of a heat engine 16 equipped with a motor rotor (not shown) similar to the pump rotor 190, the direction of rotation would be opposite that indicated by the arrow 210 and working fluid would then push against such a driving face 208 so that the respective vanes 192 would push against their bearings 202 to cause such a motor rotor to rotate during expansion of the working fluid.

A spring 214, such as a small helical coil spring, may be held in a suitable housing such as a tubular bore 216 defined in the pump rotor 119 to urge a plunger 218 outward from within the housing 216, so as to press against an inner face 220 of a vane 192. Several such plunger and spring arrangements may be provided at locations spaced apart along each vane 192, although only a single such plunger and spring arrangement is shown in FIG. 11, for the sake of simplicity.

A conduit 222 may be defined in the form of an annular groove centered about the shaft 28 in the otherwise generally flat surface of the interior face of the pump chamber outer end member 26′, to allow working gas pressure to be equalized among the receptacles 200 beneath the vanes 192.

For operation of the heat engine 16 as a Stirling cycle engine, a compressible working fluid, preferably having a high specific heat, must be contained within the system including the motor chamber 55, pump chamber 57, heat exchangers 36 and 44 and connecting conduits 34, 40, 42, and 46. For example, a gas such as helium or nitrogen may be used, as may other gases or mixtures of gas not including oxygen, and the particular fluid may be chosen for various reasons or combinations of reasons. A suitable lubricant capable of withstanding the pressures and temperatures to be encountered may be included in the working fluid.

In operation of the heat engine 16 as a Stirling cycle engine heat must be added to the working fluid within the heat exchanger 36, as by the use of a heat source such as a gas burner (not shown), for example. Alternatively, the heat exchanger 36 may be of another design (not shown) in order to utilize other available sources of heat, such as geothermal heat.

The heated working fluid exits from the heat exchanger 36 via the conduit 40 and thence proceeds via the motor inlet port 118 into a respective compartment 113 between successive vanes 108 in the interior of the motor chamber 55, where it can expand, acting upon the motor vanes 108 to urge the motor rotor 80 to rotate in the direction indicated by the arrow 126 in FIG. 4.

The then-expanded working fluid can exit from the motor chamber 55 through the motor outlet port 122 and then proceed via the conduit 42 into the heat exchanger 44, where its temperature is then reduced by transfer of heat to a cooling fluid passing through the heat exchanger 44 via the ports 45. The heat exchanger 44, depending on its design, may utilize an available source of cold water, such as a nearby river, or any other available source of a circulating fluid capable of carrying heat away from the working fluid of the heat engine 16.

Chilled working fluid passes from the heat exchanger 44 through the conduit 46 into the pump inlet port 146. Within the pump chamber 57 the working fluid is compressed in each compartment 144 to a smaller volume and accordingly greater pressure as the respective vanes 138 move within the pump chamber 57. The compressed working fluid exits from the pump chamber 57 via the pump outlet port 150 and then passes through the conduit 34 back into the heat exchanger 36, to be heated again to repeat the cycle.

The energy imparted into the working fluid by the heat exchanger 36 is utilized in expansion in the compartments 113 in the motor chamber 55, forcing the motor rotor 80 to rotate, which in turn causes the shaft 28 to rotate and thus turns the pump rotor 90. Because the volume of the pump chamber 57 is less than that of the motor chamber 55, and because the pressure of the expanded and cooled working fluid has been reduced, less energy is utilized by the pump portion 20 in compressing the working fluid than is imparted to the combination of rotors and the shaft 28 by expansion of the heated working fluid within the motor chamber 55. The excess energy is imparted to the motor rotor 80 and, aside from usual friction and other losses is available at the power takeoff end 30 of the shaft 28.

Since the shaft bearing housing in the motor chamber out end member 24 is closed, and since the shaft receiving opening 29 through the center wall 22 communicates only between the pump the motor chamber 55 and the pump chamber 57, working fluid is not free to escape around the shaft 28 except through the bore extending through the pump chamber outer end member 26, where the cascade of several O-rings 33 is provided as a shaft seal to minimize leakage of working fluid from the heat engine 16. To compensate for any leakage which does occur, an appropriate fill valve arrangement may be utilized at the fitting 48 shown in FIG. 2. The working fluid pressure range and temperature range for the heat engine 16 may be determined in view of the selection of materials available for use in construction of the heat exchangers 36 and 44, and in view of the heat supply and chilling fluid supplies available. By appropriate design of the heat exchanger 36 and the heat exchanger 44, it may be possible to extract more energy from a given amount of fuel burned than is possible with a Stirling cycle engine utilizing a reciprocating piston and displacer mechanism.

Since the rate of heating the working fluid is not instantaneously controllable by interruption of provision of heat to the heat exchanger 36, circulation of the working fluid may be controlled to stop the rotation of the shaft 28 quickly by opening the bypass valve 52 to permit working fluid to flow directly from the conduit 40 to the conduit 42 and thence into the heat exchanger 44, bypassing the motor chamber outer end member 24 during the time when the working fluid continues to be heated.

While the apparatus has been described as it would be used primarily as a heat engine, the same apparatus with some modification could be used as a heat pump, to extract heat from the circulating fluid in the heat exchanger 44 and transfer heat to the heat exchanger 36 by driving the shaft 28 to rotate opposite the direction indicated by the arrows 126 and 142. Because the volumetric capacity of the motor chamber 55 is larger than that of the pump chamber 57, operation in a heat pump mode may be enhanced by providing a bypass conduit 224 and a control valve 226, shown schematically in FIG. 2, to allow working fluid to bypass the pump portion 20 in passing from the heat exchanger 36 to the heat exchanger 44.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

1. A rotary heat engine, comprising:
(a) a pump body defining a pump chamber having a length, a maximum lateral dimension, a central end and an outer end and an interior pump chamber wall surface;
(b) a motor body defining a motor chamber located endwise adjacent the pump body, the motor chamber having a length, a maximum lateral dimension, a central end and an outer end and an interior motor chamber wall surface;
(c) a center wall located between the pump chamber and the motor chamber and closing said central end of each of the pump and motor chambers;
(d) a drive shaft extending longitudinally through said pump chamber and said motor chamber and supported for rotation therein in an eccentric location in each of said chambers;
(e) a pump rotor mounted on the drive shaft for rotation therewith within the pump chamber, said pump rotor having a diameter smaller than said maximum lateral dimension of said pump chamber and having a plurality of pump vanes carried thereon in sealing contact with said interior pump chamber wall surface of the pump chamber;
(f) a motor rotor mounted on the shaft for rotation therewith within the motor chamber, the motor rotor having a diameter smaller than said maximum lateral dimension of said motor chamber and having a plurality of motor vanes movably mounted thereon in sealing contact with said interior motor chamber wall surface of the motor chamber;
(g) a pump chamber outer end member defining a pump inlet port and a pump outlet port communicating with an interior space within said pump chamber between said pump rotor and said interior pump chamber wall surface;
(h) a motor chamber outer end member defining a motor inlet port and a motor outlet port communicating with an interior space within said motor chamber between said motor rotor and said interior motor chamber wall surface;
(i) a high temperature heat exchanger connected to conduct a quantity of a working fluid between said pump outlet port and said motor inlet port and impart heat to said working fluid; and
(j) a low temperature heat exchanger connected to conduct a quantity of a working fluid between said motor outlet port and said pump inlet port and to remove heat from said working fluid.

2. The heat engine of claim 1 including a working fluid bypass conduit interconnecting said motor inlet port with said motor outlet port and a bypass throttle valve arranged in said bypass conduit so as to selectively permit working fluid to pass from said motor inlet port to said motor outlet port without passing through said motor chamber.

3. The rotary heat engine of claim 1 wherein said pump rotor includes a plurality of radially extending vane-receiving slots and a respective one of said pump vanes is slidably received in each of said plurality of slots, and wherein said pump chamber end member defines a working fluid conduit in fluid communication with said pump outlet port and that is aligned with and is in fluid communication with a radially inner portion of each of said vane-receiving slots.

4. The rotary heat engine of claim 3 wherein each of said vanes includes an outer margin including a lubricant-carrying shelf spaced apart from said interior surface of said pump chamber and providing a gap exposing said shelf to working fluid pressure.

5. The rotary heat engine of claim 1 wherein said motor rotor includes a plurality of radially extending vane-receiving slots and a respective one of said motor vanes is slidably received in each of said plurality of vane-receiving slots, and wherein said motor rotor defines a working fluid conduit extending radially inward adjacent one of said motor vanes and communicating between a space inside the motor chamber located radially outward from the motor rotor and a space beneath said one of said motor vanes, thereby conducting a quantity of a working fluid beneath said one of said motor vanes so as to urge said one of said motor vanes radially outwardly in a respective one of said vane-receiving slots.

6. The rotary heat engine of claim 5 wherein each of said motor vanes has a thickness and includes an outer margin including an inclined lubricant-collecting surface and a chamber-contacting tip surface having a width that is smaller than said thickness of said motor vane.

7. The heat engine of claim 1 wherein at least one of said rotors includes a plurality of pivots defining pivot axes oriented parallel with said drive shaft and a plurality of pivotable gate vanes supported in said pivots and extending from said rotor into sealing contact against an interior surface of a respective one of said pump chamber and said motor chamber.

8. The heat engine of claim 7 wherein a respective chamber end member of at least one of said pump chamber and said motor chamber defines a working fluid channel in communication with a space between a respective rotor and one of said pivotable gate varies associated with said respective rotor and wherein said working fluid channel also is in fluid communication with a working fluid inlet port defined in said chamber end member, whereby a quantity of said working fluid can flow to equalize pressures beneath said pivotable gate vanes.

9. The heat engine of claim 1 wherein said center wall defines a working fluid conduit extending therealong through an angular distance about said drive shaft in a location adjacent one of said vanes, so that working fluid is free to move around said one of said vanes through said angular distance so as to induce flow of a quantity of said working fluid longitudinally along said rotor.

10. The heat engine of claim 1 wherein said diameters of said motor rotor and said pump rotor are equal.

11. The heat engine of claim 1 wherein at least one of said pump chamber and said motor chamber is a circular cylinder and includes a floating liner sleeve.

12. The heat engine of claim 1 including an annular groove defined in at least one of said pump rotor and said pump chamber outer end member, said annular groove surrounding said drive shaft and being in fluid communication with a respective pump vane root space between a root of each said pump vane and said pump rotor, and said heat engine also including a generally radial groove defined in said pump chamber outer end member and communicating with said annular groove and with a portion of said pump chamber located radially outward of said pump rotor and in fluid communication with said pump outlet port, whereby working fluid under pressure is conducted to each said respective pump vane root space so as to urge each pump vane outward against an arcuate interior surface of said pump chamber.

13. The rotary heat engine of claim 12 wherein said motor rotor includes a plurality of radially extending vane-receiving slots and a vane slidably received in each of said plurality of slots, and wherein said motor rotor defines a working fluid conduit extending radially inward adjacent one of said vanes and communicating between a space inside the chamber located radially outward from the motor rotor and a motor vane root space beneath said one of said vanes, thereby conducting a quantity of a working fluid beneath said one of said vanes so as to urge said one of said vanes radially outwardly in a respective one of said vane-receiving slots, whereby respective motor vane root spaces are exposed to working fluid under cyclically changing pressures during rotation of said motor rotor.

14. The rotary heat engine of claim 1 wherein at least one of said motor inlet port, said motor outlet port, said pump inlet port, and said pump outlet port is tapered from a wide end where radial clearance between the respective rotor and the respective interior chamber wall surface is greater, to a narrowest part where said respective rotor is closer to said respective interior chamber wall surface.

15. The rotary heat engine of claim 14, wherein said wide end of said motor inlet port is separated angularly from said wide end of said motor outlet port, by an angle about said axis of rotation that is substantially equal to an angular separation between successive ones of said vanes.

16. The rotary heat engine of claim 14, wherein said wide end of said pump inlet port is separated angularly from said wide end of said pump outlet port, by an angle about said axis of rotation that is substantially equal to an angular separation between successive ones of said vanes.
